(19) United States
(12) Patent Application Publication
(10) Pub. No.: US 2009/0028664 A1
(43) Pub. Date: Jan. 29, 2009

(54) FASTENER ASSEMBLY

(75) Inventors: WEN-TANG PENG, Tu-Cheng (TW); GUANG-YI ZHANG, Shenzhen (CN); XIAO-ZHENG LI, Shenzhen (TW)

Correspondence Address: PCE INDUSTRY, INC.;ATT. CHENG-JU CHIANG, 458 E. LAMBERT ROAD, FULLERTON, CA, 92835, US

(73) Assignees: HONG FU JIN PRECISION INDUSTRY (ShenZhen) CO., LTD, Shenzhen City (CN); HON HAI PRECISION INDUSTRY CO., LTD., Tu-Cheng (TW)

(21) Appl. No.: 11/963,874

(22) Filed: Dec. 24, 2007

(30) Foreign Application Priority Data
Jul. 26, 2007 (CN) 200710201180.X

(51) Int. Cl. F16B 35/00; F16B 35/04

(52) U.S. Cl. 411/383; 411/411

(57) ABSTRACT

A fastener assembly includes a drive shaft, a threaded shaft, and a joint portion. The drive shaft is used for being operated to rotate around an axis thereof. The threaded shaft has a thread thereon, and is used for being screwed into an object. The joint portion is used for connecting the drive shaft with the threaded shaft. The joint portion is able to transfer the rotation of the drive shaft to the threaded shaft, and allow the rotations of the drive shaft and the threaded shaft about different axes.

### BACKGROUND

1. Field of the Invention

The present invention generally relates to fastening apparatuses. Particularly, the present invention relates to a fastener assembly.

2. Description of Related Art

Screws are commonly used for connecting two or more objects together. Generally, a common screw includes head with a means for mating with driver for being rotated about its axis of rotation, and a threaded shaft connected to the head and sharing the same axis of rotation. The common screw is designed to be received in a linear threaded hole. However, in some circumstances the threaded hole is not linear along its entire length, therefore common screws cannot be used.

### SUMMARY

In one embodiment, a fastener assembly includes a drive shaft, a threaded shaft, and a joint portion. The drive shaft is used for driving the fastener assembly to rotate about an axis thereof. The threaded shaft if for threadingly engaging the fastener assembly in a receiving hole of an object. The joint portion is used for connecting the drive shaft to the threaded shaft. The joint portion is able to transmit torque from the drive shaft to the threaded shaft, and allows rotation of the drive shaft and the threaded shaft about different axes.

Other advantages and novel features of the fastener assembly will become more apparent from the following detailed description of preferred embodiments when taken in conjunction with the accompanying drawings, in which:

### BRIEF DESCRIPTION OF THE DRAWINGS

FIG. 1 is an exploded, isometric view of a fastener assembly in accordance with an exemplary embodiment of the present invention;

FIG. 2 is similar to FIG. 1, but viewed from another aspect;

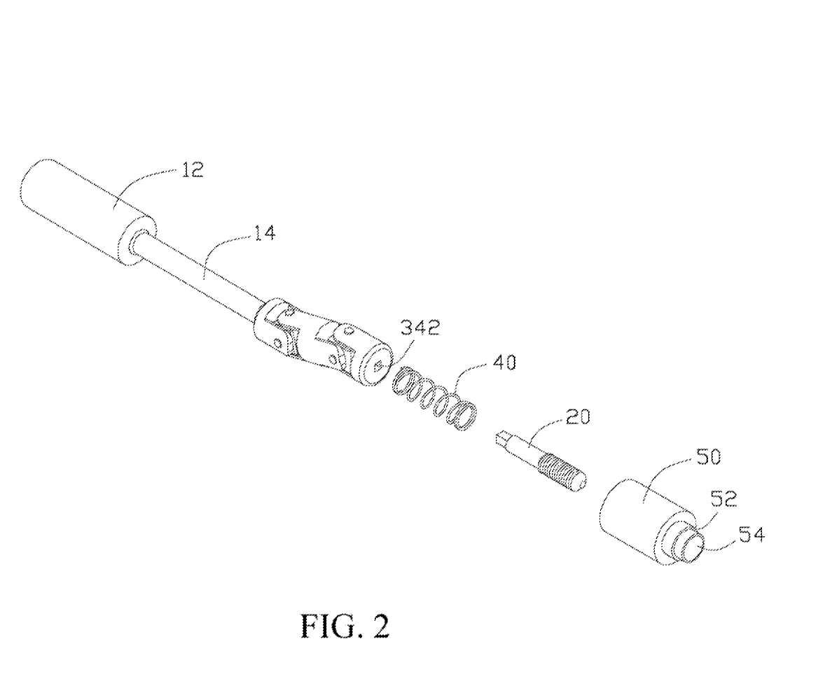

FIG. 3 is an assembled view of FIG. 1;

FIG. 4 is similar to FIG. 3, but viewed from another aspect, and showing a partially cross-sectional view; and

FIG. 5 shows a using state of the fastener assembly of FIG. 1, together with a box and a bracket.

### DETAILED DESCRIPTION

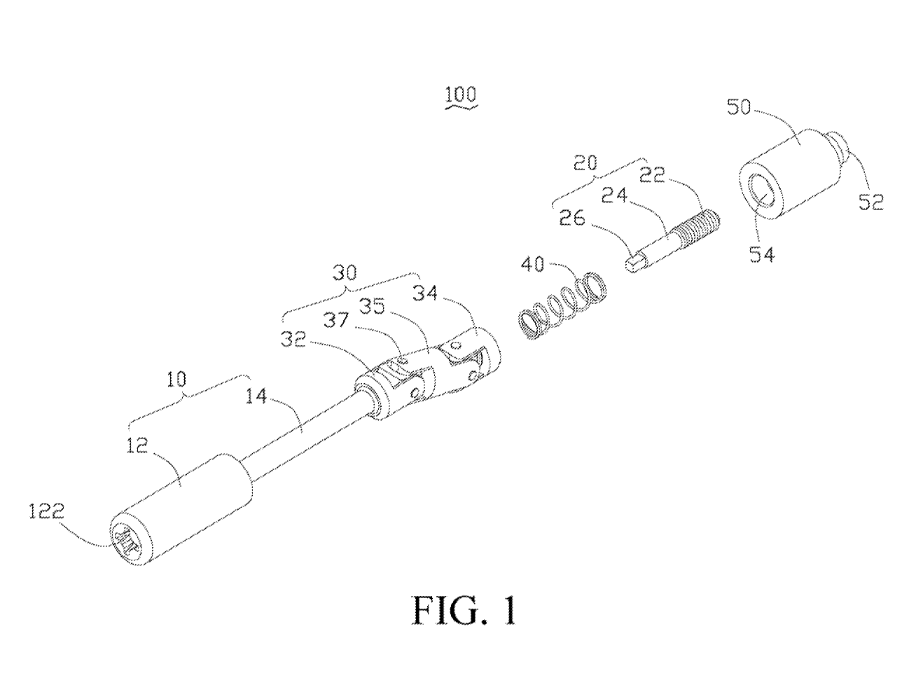

Referring to FIG. 1, a fastener assembly 100 in accordance with an exemplary embodiment includes a drive shaft 10, a threaded shaft 20, a joint portion 30, an elastic element 40, and a sleeve portion 50. The drive shaft 10 is connected to the threaded shaft 20 via the joint portion 30, so that the drive shaft 10 can be rotatable about a different axis with respect to the threaded shaft 20.

The drive shaft 10 includes a head 12 and a shaft 14 that is coaxially formed with the head 12. In one embodiment, the head 12 and the shaft 14 are integrally formed. In another embodiment, the head 12 and the shaft 14 are connected and immovably fixed to each other. One end of the head 12 is connected to the shaft 14, and on the other end of the head 12, an engaging slot 122 is formed to be engaged with tools, such as screwdrivers (not shown).

The threaded shaft 20 has a pole 24, and a thread 22 formed on an outer surface of an end of the pole 24. On the other end of the pole 24, a block 26 is firmly attached. The block 26 can have a triangular, rectangular or any other polygonal shape in cross-section. The block 26 can be fixed on the end of the pole 24 or integrally formed with the pole 24.

The joint portion 30 is essentially two universal joints (U-joints) connected by an intermediate shaft and includes a first end element 32, a second end element 34, an intermediate element 35, and two cross shafts 37 that respectively interconnect the first and second end elements 32, 34 to opposite ends of the intermediate element 35 forming the two U-joints.

One end of the first end element 32 is immovably connected to the shaft 14 of the drive shaft 10. One end of the second end element 34 defines a hole 342 therein, for receiving the block 26 of the threaded shaft 20. The hole 342 has a cross section corresponding to that of the block 26.

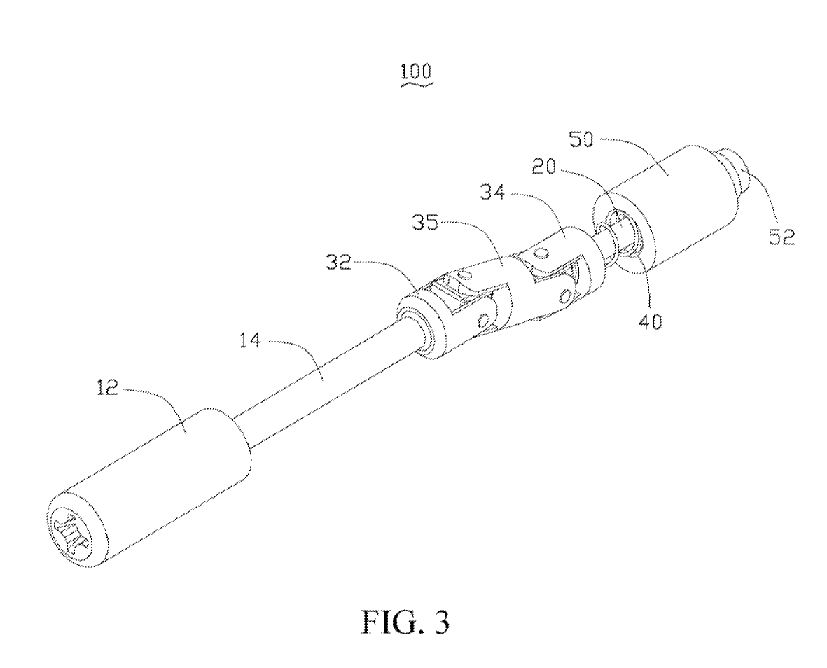

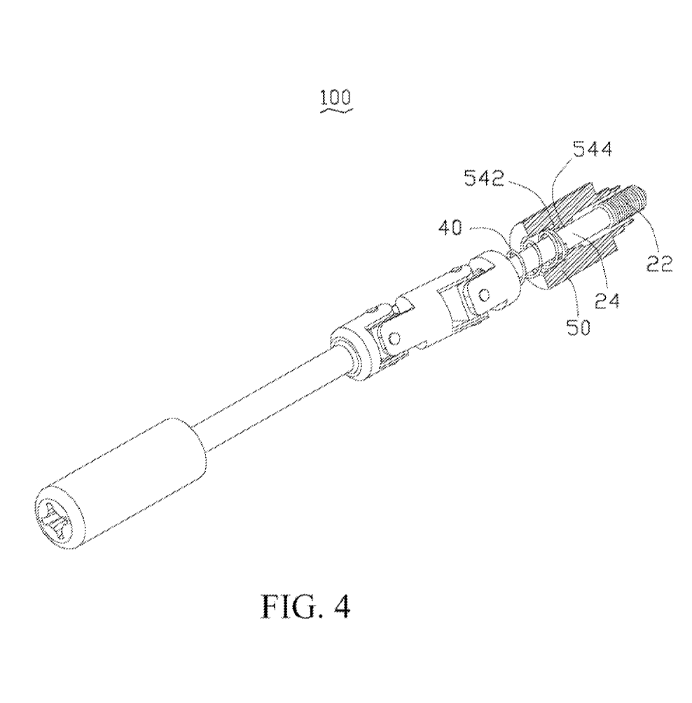

Referring also to FIGS. 3 and 4, the sleeve portion 50 is cylinder-shaped, with a protrusion 52 protruding from an end thereof. The sleeve portion 50 is provided to guide the threaded shaft 20 to an internally threaded portion of a hole. The sleeve portion 50 defines a through hole 54 along a longitudinal direction thereof, extending through the cylinder and the protrusion 52. A resist ring 542 protrudes from an inner surface of the through hole 54, for resisting an end of the elastic element 40. A support ring 544 further protrudes from the resist ring 542, to have a smaller diameter than that of the resist ring 542.

In assembly, the block 26 of the threaded shaft 20 is received in the hole 342 of the joint portion 30. The threaded shaft 20 is sleeved in the elastic element 40 which is a helical spring in the embodiment, with an end of the elastic element 40 resisting against the base of the second end element 34 of the joint portion 30. The thread 22 of the threaded shaft 20 passes through the through hole 54 of the sleeve portion 50. The other end of the elastic element 40 is resisted against the resist ring 542, for providing a resistance against the joint portion 30 and the sleeve portion 50.

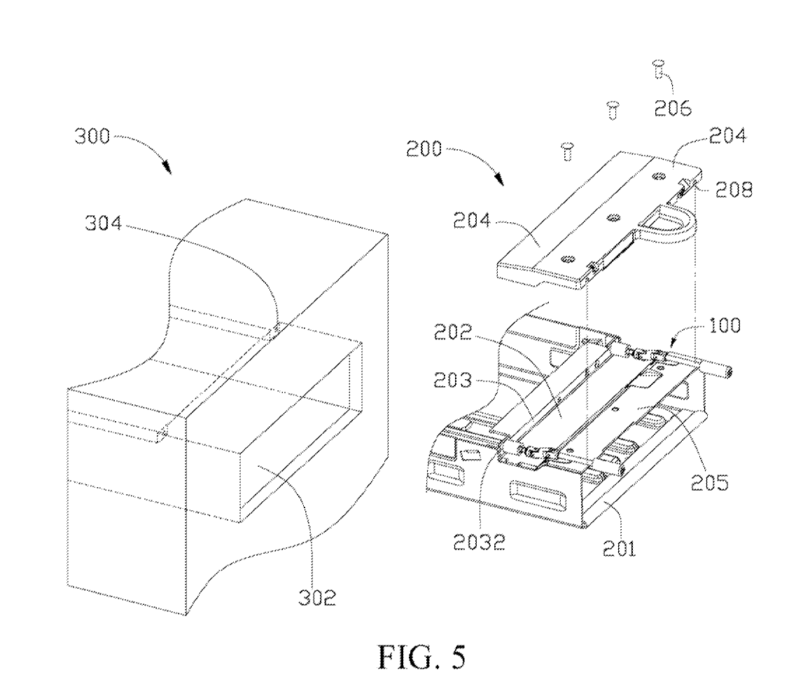

Referring to FIG. 5, in use, two fastener assemblies 100 according to the above-mentioned embodiment are used for fixing a box 200 to a bracket 300. The box 200 includes a bottom wall 201 and an insulating wall 202, which is generally parallel to the bottom wall 201. An upright wall 203 perpendicularly extending from the insulating wall 202 is used for fixing the sleeve portions 50 of the fastener assemblies 100. The upright wall 203 defines two engaging holes 2032 therein, for receiving the protrusions 52 of the corresponding sleeve portions 50, thereby fixing the sleeve portions 50. A cover 204 is used for shielding the fastener assemblies 100, the insulation wall 202, and the upright wall 203. The cover 204 can be fixed to the box 200 through rivets 206. The cover 204 further defines two openings 208 therein, for allowing the shafts 14 of the drive shafts 10 of the fastener assemblies 100 to extend through.

In fixing the box 200 to the bracket 300, the sleeve portions 50 of the fastener assemblies 100 are resisted against the upright wall 203 of the box 200, and the protrusions 52 of the fastener assemblies 100 are received in the corresponding engage holes 2032 in the upright wall 203. The box 200 is inserted into the bracket 300, and the drive shafts 10 of the fastener assemblies 100 are rotated about axes thereof. The drive shafts 10 can be rotated by hand or by using screwdrivers (not shown) to be engaged in the engaging slots 122. Torque applied to each of the drive shafts 10 is transmitted to the threaded shafts 20 through the joint portions 30. Thus the threads 22 that extend through the sleeve portions 50 are screwed into threaded holes 304 that are defined in the bracket 300. Therefore, the box 200 is fixedly received in the bracket 300.

The embodiments were chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A fastener assembly comprising:
a drive shaft for being operated to rotate around an axis thereof;
a threaded shaft for being screwed into an object; and
a joint portion for connecting the drive shaft to the threaded shaft, the joint portion being able to transmit torque from the drive shaft to the threaded shaft, and allow rotation of the drive shaft and the threaded shaft about different axes.

2. The fastener assembly as described in claim 1, wherein the joint portion comprises:
a first end element connecting to the drive shaft; and
an intermediate element connected between the first end element and the threaded shaft, the intermediate element connected to the first end element through a universal joint.

3. The fastener assembly as described in claim 1, wherein the joint portion comprises:
a second end element connecting to the threaded shaft; and
an intermediate element connected between the second end element and the drive shaft, the intermediate element connected to the second end element through a universal joint.

4. The fastener assembly as described in claim 1, wherein the joint portion comprises:
a first end element connecting to the drive shaft;
a second end element connecting to the threaded shaft; and
an intermediate element connected between the first end element and the second end element, the intermediate element cooperating with the first and second end elements to form to universal joints, respectively.

5. The fastener assembly as described in claim 4, wherein the first end element and the second end element are each respectively connected to the intermediate element by engaging with a cross shaft.

6. The fastener assembly as described in claim 4, wherein the first end element is integrally formed with the drive shaft.

7. The fastener assembly as described in claim 4, wherein the second end element defines a hole in one end thereof, and the threaded shaft comprises a block at a relative end thereof, for being received in the hole.

8. The fastener assembly as described in claim 7, wherein the hole and the block have a same shape in cross section.

9. The fastener assembly as described in claim 1, wherein the drive shaft comprises:
a head for being operated to rotate; and
a shaft respectively connected to the head and the joint portion.

10. The fastener assembly as described in claim 9, wherein the head defines an engaging slot at a side thereof opposite to the shaft, for a screwdriver engaging therein.

11. The fastener assembly as described in claim 1, further comprising a sleeve portion for receiving the threaded shaft.

12. The fastener assembly as described in claim 11, further comprising an elastic element, two ends of the elastic element being resisted against the joint portion and the sleeve portion.

13. The fastener assembly as described in claim 12, wherein the sleeve portion defines a through hole therein, for allowing the threaded shaft extending therethrough.

14. The fastener assembly as described in claim 13, wherein the sleeve portion comprises a resist ring protruding from an inner surface of the through hole thereof, the elastic element being resisted against the resist ring.

15. The fastener assembly as described in claim 12, wherein the elastic element is a helical spring, the threaded shaft is sleeved by the spring.
